(19) United States
(12) Patent Application Publication
(10) Pub. No.: US 2024/0253589 A1
(43) Pub. Date: Aug. 1, 2024

(54) AUTOMOTIVE PROTECTIVE DEVICE TRACKING

(71) Applicant: Autoliv ASP, Inc., Ogden, UT (US)

(72) Inventors: Mark Hatfield, Providence, UT (US); Sean Bowman, Ogden, UT (US)

(21) Appl. No.: 18/104,702

(22) Filed: Feb. 1, 2023

(51) Int. Cl. B60R 21/231; B60R 21/235; G06F 16/955; G06K 19/02; G06K 19/07

(52) U.S. Cl. CPC B60R 21/231; B60R 21/235; G06F 16/955; G06K 19/027; G06K 19/0723; B60R 2021/01265; B60R 2021/23509; B60R 2021/23542

(57) ABSTRACT

An automotive protective device that can be configured to be mounted to a vehicle to provide protection to an occupant of a vehicle during a collision event. The automotive protective device may include a textile component formed of a textile and including an RFID chip, wherein the textile component is associated with an identifier of the RFID chip, and a non-textile component coupled to the textile component and associated with the identifier of the RFID chip, wherein the non-textile is associated with the identifier of the RFID chip at an assembly time when the non-textile component is coupled to the textile component.

### TECHNICAL FIELD

The present disclosure relates generally to the field of automotive protection. More specifically, the present disclosure relates to automotive protective device tracking, including trackable automotive protective devices and systems and methods of manufacturing the same, for quality control, safety control, manufacture process data collection, and/or other tracking applications.

### BACKGROUND

Inflatable airbags are examples of automotive protective devices that may be mounted within a vehicle and deploy during a collision event. The deployed airbag may cushion an occupant and prevent detrimental impact with other vehicular structures. Some airbags suffer from one or more drawbacks or may perform less than optimally in one or more respects. Safety belts are also examples of automotive protective devices that provide restraint of an occupant of a vehicle during a collision event. Some safety belts suffer from one or more drawbacks or may perform less than optimally in one or more respects. Certain embodiments disclosed herein can address one or more of these issues.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered limiting of the scope of the disclosure, the embodiments will be described and explained with specificity and detail in reference to the accompanying drawings.

FIG. 1 is a partial cut-away view of a radio frequency identifier (RFID) thread, according to one or more embodiments of the present disclosure.

FIG. 2 is an elevation view of another RFID thread, according to one or more embodiments of the present disclosure.

FIG. 3 is an elevation view of a textile including RFID threads, according to one or more embodiments of the present disclosure.

FIG. 4 is a perspective view of an RFID ribbon attached to a textile by staples, according to one or more embodiments of the present disclosure.

FIG. 5 is an elevation view of an RFID ribbon attached to a textile by an adhesive, according to one or more embodiments of the present disclosure.

FIG. 6 is an elevation view of an RFID ribbon sewn to a textile, according to one or more embodiments of the present disclosure.

FIG. 7 is a side view of a vehicle interior including an automotive protective device, according to one or more embodiments of the present disclosure.

FIG. 8 is a cross-section view of an automotive protective device, according to one or more embodiments of the present disclosure.

FIG. 9 is a front view of a vehicle seating position illustrating another automotive protective device, according to one or more embodiments of the present disclosure.

FIG. 10A is a diagrammatic view of a tracking system, according to one or more embodiments of the present disclosure.

FIG. 10B is a diagrammatic view of a tracking system in communication with a quality assurance system, according to one or more embodiments of the present disclosure.

FIG. 11 is a flowchart illustrating operations of a method for tracking an automotive protective device, according to one or more embodiments of the present disclosure.

### DETAILED DESCRIPTION

As can be readily understood, the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

Automotive protective devices may be used to prevent or mitigate injury to an automotive vehicle occupant in the event of a crash. Automotive protective devices may include seatbelts, airbags, nets, cushions, and other devices. Automotive protective devices may mitigate injuries caused by rapid deceleration of the vehicle occupant in the event of a crash. Automotive protective devices may prevent collision of the vehicle occupant with vehicle structures such as a beam, a dashboard, or other structures.

Inflatable airbag systems are widely used to reduce or minimize occupant injury during a collision event. Airbag modules have been installed at various locations within a vehicle, including, but not limited to, in the steering wheel, in the dashboard and/or instrument panel, within the side doors or side seats, adjacent to a roof rail of the vehicle, in an overhead position, or at the knee or leg position.

During installation, the disclosed airbags are typically disposed at an interior of a housing in a packaged state (e.g., are rolled, folded, and/or otherwise compressed) or a compact configuration and may be retained in the packaged state behind a cover. During a collision event, an inflator is triggered, which rapidly fills the airbag with inflation gas. The airbag can rapidly transition from the packaged state of the compact configuration to an expanded state of a deployed configuration. For example, the expanding airbag can open an airbag cover (e.g., by tearing through a burst seam or opening a door-like structure) to exit the housing. The inflator may be triggered by any suitable device or system, and the triggering may be in response to and/or influenced by one or more vehicle sensors.

An airbag assembly, or airbag system, can mitigate injury to an occupant of a vehicle during a collision event by reducing the effect of impact of the occupant against structures (body-structure impact) within the vehicle (such as, e.g., a dashboard, or door column).

Seat belts, or restraining devices have been used to restrain passengers and mitigate injuries due to vehicle collisions. Seat belts may include a lap belt and a shoulder belt. Seat belts may buckle to secure a vehicle occupant in a vehicle occupant seating position. Seat belts may extend from a spooled configuration to extend over an occupant. Seat belts may include mechanisms which prevent them from extending during a collision. Some seat belts may include mechanisms which prevent seat belts from extending at speeds exceeding a threshold.

To successfully protect vehicle occupants in the event of a collision, automotive protective devices must be reliable. Some automotive protective devices do not function correctly after being used. For example, some airbags can only be used once. Thus, quality controls are an important part of manufacturing automotive protective devices. Batch testing of automotive protective devices, along with other manufacturing controls, may ensure reliability of automotive protective devices. In some instances, recalls are required to ensure that automotive protective devices will function properly. In the case of recall, it is important to know which automotive protective devices are affected by the recall. Recalling too few devices may result in some unreliable devices remaining in vehicles while recalling too many devices may result in waste.

Conventional systems for tracking automotive protective devices during manufacture often rely on scanning bar code labels attached to automotive protective device components. These systems require workers to locate and correctly scan the bar code labels on the automotive protective device components, delaying the manufacturing process. Additionally, some bar code labels cannot be scanned once the automotive protective devices are assembled. For example, internal components of the automotive protective devices may have bar code labels which are not visible and which cannot be scanned when the automotive protective devices are assembled.

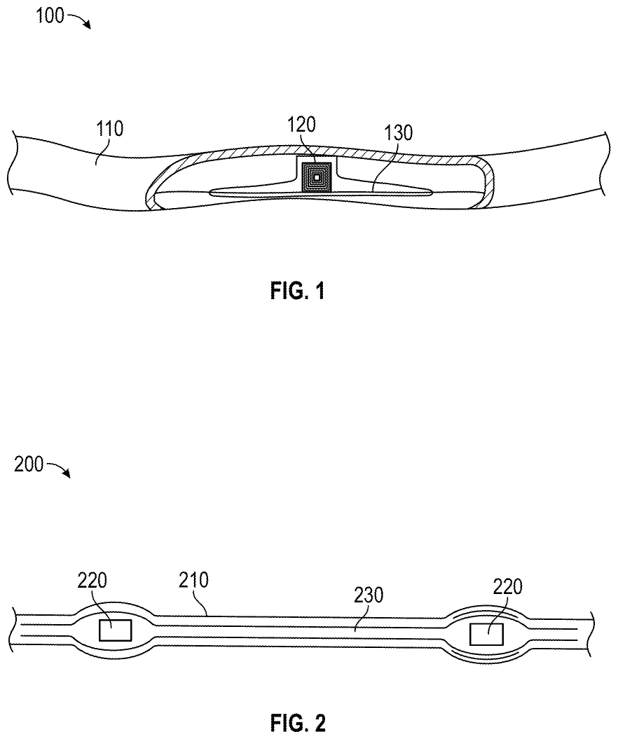

FIG. 1 illustrates a radio frequency identifier (RFID) thread 100, according to one or more embodiments of the present disclosure. The RFID thread 100 may also be called an RFID yarn 100. The RFID thread 100 may include a thread body 110, an RFID chip 120, and an antenna 130. The RFID chip 120 and the antenna 130 may be housed inside the thread body 110, also called the yarn body 110. The RFID chip 120 may be connected to the antenna 130. The antenna 130 may allow the RFID chip 120 to receive and/or emit electromagnetic signals. The RFID chip 120 may emit a signal, or identifier, when scanned. The RFID chip 120 may be sized to fit within or be incorporated within the thread body 110. The RFID chip 120 may be integral to the thread body 110. The thread body 110 may be sized similar to a thread or yarn. The thread body 110 may comprise fibrous material, rubber, plastic, or another material. The thread body 110 may be flexible. The antenna 130 may be flexible, allowing the RFID chip 120 to emit the signal or identifier when the RFID thread 100 is bent, looped, or coiled.

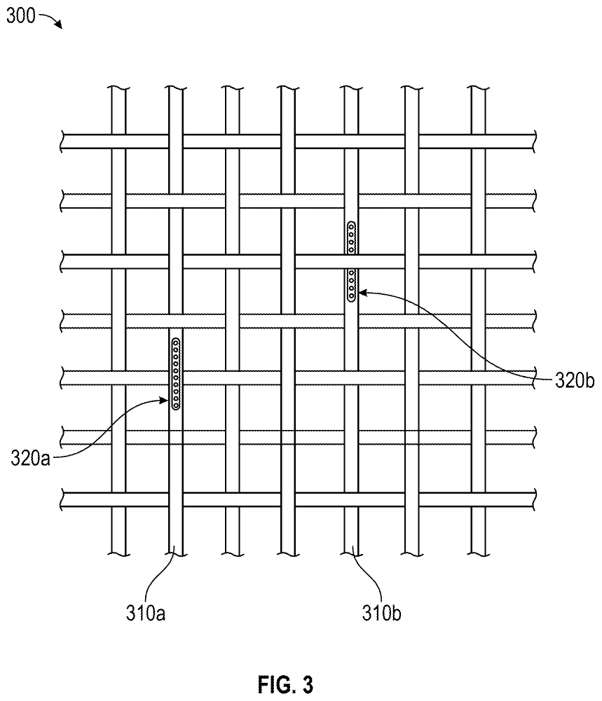

FIG. 2 illustrates another RFID thread 200, according to one or more embodiments of the present disclosure. The RFID thread 200 may include a thread body 210, also called a yarn body 210. The thread body 210 may be sized similar to a thread or yarn. The thread body 210 may include fibrous material, rubber, plastic, or another material. The thread body 210 may be flexible. The RFID thread 200 may include a plurality of RFID chips 220. The plurality of RFID chips 220 may be incorporated in or integral to the thread body 210. The plurality of RFID chips 220 may emit signals or identifiers when scanned. In some embodiments, the plurality of RFID chips 220 may each emit a same signal or identifier. In other embodiments, the plurality of RFID chips 220 may each emit a different signal or identifier. In yet other embodiments, a first subset of the plurality RFID chips 220 may emit a first signal or identifier and a second subset of the plurality of RFID chips 220 may emit a second signal or identifier. The RFID thread 200 may include an antenna 230. The antenna 230 may be connected to the plurality of RFID chips 220. In some embodiments, the antenna 230 may be continuous. In other embodiments, the antenna 230 may be interrupted such that a first portion of the antenna 230 is connected to a first RFID chip of the plurality of RFID chips 220 and a second portion of the antenna 230 is connected to a second RFID chip of the plurality of RFID chips 220. The antenna(s) of the plurality of RFID chips 220 may be flexible, allowing the plurality of RFID chips 220 to emit the signals or identifiers when the RFID thread 100 is bent, looped, coiled, or the like. In some embodiments, the plurality of RFID chips 220 are evenly spaced. In other embodiments, the plurality of RFID chips 220 are not evenly spaced. A distance between subsequent RFID chips may range from 1 mm to 1 foot.

In some embodiments, the RFID thread 200 may be incorporated in a seam tape. In some embodiments, the RFID thread 200 may be incorporated in the seam tape as the seam tape is produced. The RFID thread 200 may be integral to the seam tape. The seam tape may be used to join seams of an airbag cushion during sewing of the airbag cushion. In some embodiments, the plurality of RFID chips 220 may each emit the same signal or identifier. During sewing of the airbag cushion, a subset of the plurality of RFID chips 220 may be destroyed and a second subset of the plurality of RFID chips 220 may survive. During deployment of the airbag cushion, a third subset of the second subset of the plurality of RFID chips 220 may be lost and a fourth subset of the second subset of the plurality of RFID chips 220 may remain on the airbag cushion such that the airbag cushion may be identified using the signal or identifier of the plurality of RFID chips 220.

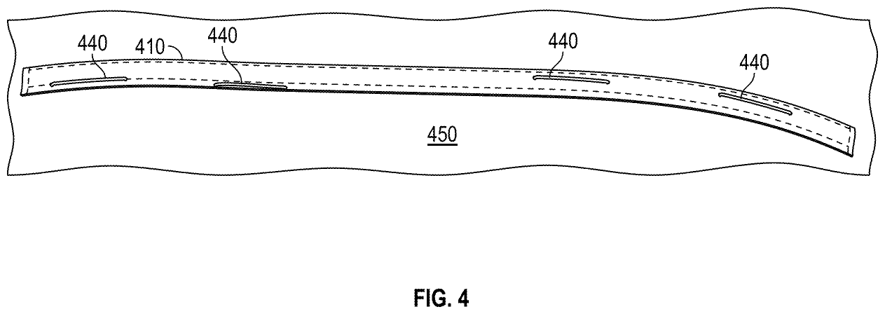

FIG. 3 illustrates a textile 300 including a first RFID thread 310a and a second RFID thread 310b, according to one or more embodiments of the present disclosure. In some embodiments, the first RFID thread 310a and the second RFID thread 310b may be the RFID thread 100 of FIG. 1 or the RFID thread 200 of FIG. 2. The first RFID thread 310a may include a first RFID chip 320a. The second RFID thread 310b may include a second RFID chips 320b. The first RFID chip 320a may emit a first signal or identifier when scanned. The second RFID chip 320b may emit a second signal or identifier when scanned. In some embodiments, the first signal or identifier may be the same as the second signal or identifier. The textile 300 may be associated with the first and second signals or identifiers. In other embodiments, the first signal or identifier may be different than the second signal or identifier. The textile 300 may be associated with the first signal or identifier, the second signal or identifier, and/or a combination. In some embodiments, the textile 300 may include a plurality of RFID threads. In some embodiments, each thread of the textile 300 may be an RFID thread. The textile 300 may include fibrous threads, rubber threads, plastic threads, or threads of another flexible material. The first RFID thread 310a and the second RFID thread 310b may each include an antenna for picking up and emitting electromagnetic signals, such as the first signal or identifier and the second signal or identifier.

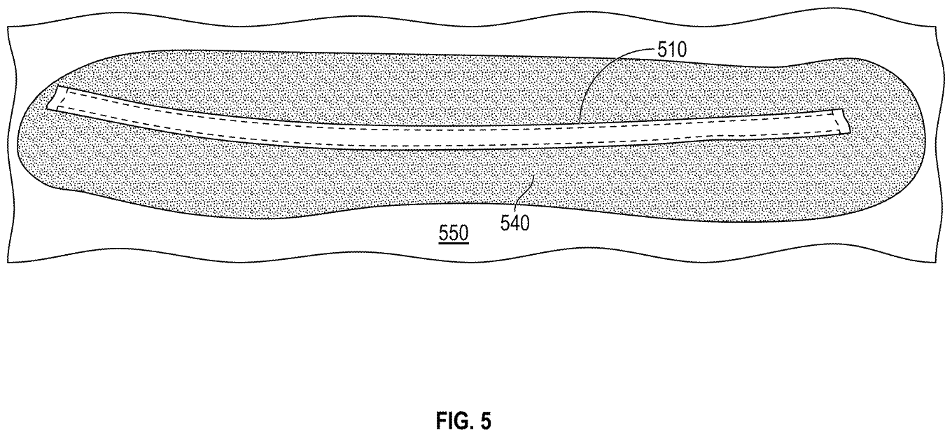

FIG. 4 illustrates an RFID ribbon 410 attached to a textile 450 by staples 440, according to one or more embodiments of the present disclosure. The RFID ribbon 400 may also be called an RFID strip 410. In some embodiments, the RFID ribbon 410 may include an RFID chip and an antenna attached to the RIFD chip inside the RFID ribbon 410. The RFID chip and antenna may be similar to the RFID chip 120 and antenna 130 of FIG. 1. In other embodiments, the RFID ribbon 410 may include an RFID thread incorporated into a fabric or a stitching of the RFID ribbon 410. The RFID ribbon 410 may be attached to the textile 450 by the staples 440, also termed fasteners. The staples 440, or fasteners, may pierce the RFID ribbon 410 and the textile 450 to attach the RFID ribbon 410 to the textile 450. Although four staples 440 are pictured, any number of staples may be used to attach the RFID ribbon 410 to the textile 450. The staples 440 may be metal, plastic, polymer, or any other suitable material.

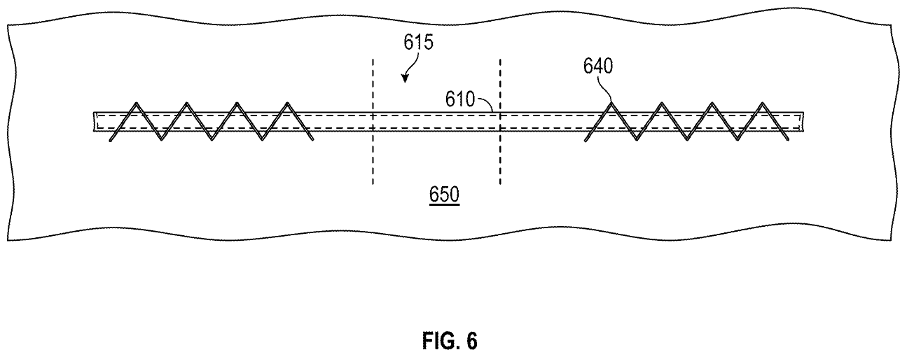

FIG. 5 illustrates an RFID ribbon 510 attached to a textile 550 by an adhesive 540, according to one or more embodiments of the present disclosure. The RFID ribbon 500 may also be called an RFID strip 510. In some embodiments, the RFID ribbon 510 may include an RFID chip and an antenna attached to the RIFD chip inside the RFID ribbon 510. The RFID chip and antenna may be similar to the RFID chip 120 and antenna 130 of FIG. 1. In other embodiments, the RFID ribbon 510 may include an RFID thread incorporated into a fabric or a stitching of the RFID ribbon 510. The adhesive 540 may be a thermal-cured adhesive, a UV-cured adhesive, or another type of adhesive. In some embodiments, the adhesive 540 may be between the RFID ribbon 510 and the textile 550. In other embodiments, the adhesive 540 may include a first adhesive below the RFID ribbon 510 on the textile 550 and a second adhesive above the RFID ribbon 510.

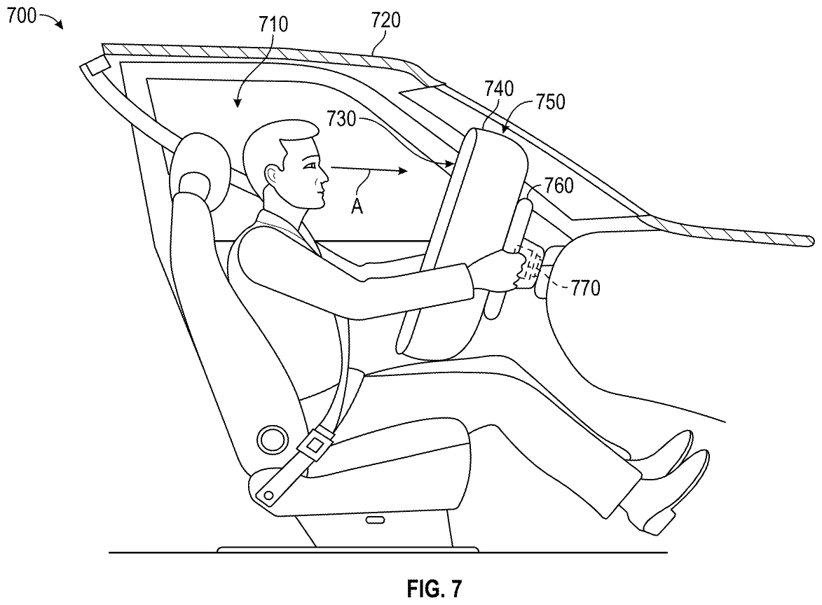

FIG. 6 illustrates an RFID ribbon 610 sewn to a textile 650, according to one or more embodiments of the present disclosure. The RFID ribbon 600 may also be called an RFID strip 610. In some embodiments, the RFID ribbon 610 may include an RFID chip and an antenna attached to the RIFD chip inside the RFID ribbon 610. The RFID chip and antenna may be similar to the RFID chip 120 and antenna 130 of FIG. 1. In other embodiments, the RFID ribbon 610 may include an RFID thread incorporated into a fabric or a stitching of the RFID ribbon 610. The RFID ribbon 610 may be sewn to the textile 650 by stitching 640. The stitching 640 may cross over the RFID ribbon 610. In some embodiments, the stitching 640 may pierce the RFID ribbon 610. In some embodiments, the stitching 640 may attach one end of the RFID ribbon 610 to the textile 650. In other embodiments, the stitching 640 may attach both ends of the RFID ribbon 610 to the textile 650. The RFID ribbon 610 may include an RFID chip area 615. The RFID chip may be located in the RFID chip area 615. The stitching 640 may not extend into the RFID chip area 615. In some embodiments, the antenna may be located in the RFID chip area 615. In other embodiments, the antenna may extend past the RFID chip area 615. The antenna may be covered by the stitching 640. Although the RFID chip area 615 is shown as occupying a central portion of the RFID ribbon 610, the RFID chip area 615 may be any portion of the RFID ribbon 610.

In some embodiments, the stitching 640 may include metal thread or metal-coated thread and may cross the antenna, allowing the stitching 640 to function as an additional antenna. In some embodiments, the RFID ribbon 610 may not include an antenna and the stitching 640 may contact a lead of the RFID chip to function as the antenna. In some embodiments, the stitching may cross the RFID chip area 615 to contact the antenna and/or the lead of the RFID chip.

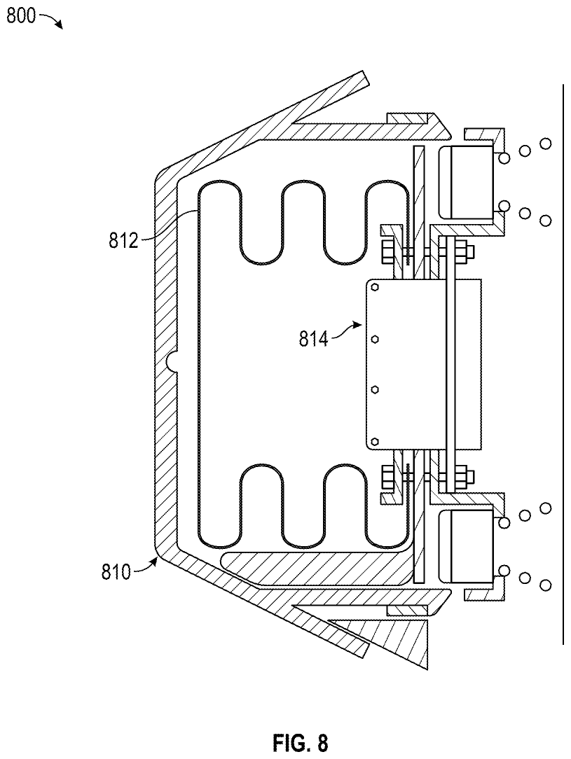

FIG. 7 illustrates a vehicle interior 700 including an automotive protective device 750, according to one or more embodiments of the present disclosure. The vehicle interior 700 may include an occupant seating position 710 for receiving a vehicle occupant. During a collision event, the vehicle occupant may move rapidly in a direction A, resulting in injury upon striking a vehicle body 720. To protect the vehicle occupant, the automotive protective device 750 may be configured to slow the movement of the vehicle occupant in the direction A. The automotive protective device 750 may include a front panel 730 and a side panel 740. The front panel 730 and the side panel 740 may be textile components of the automotive protective device 750. The front panel 730, the side panel 740, or any other textile components of automotive protective device 750 may include a RFID thread or RFID ribbon, as discussed herein. The front panel 730 and the side panel 740 may be configured to be rapidly inflated to provide a cushion for the vehicle occupant. The automotive protective device 750 may include an inflator 770 configured to inflate the front panel 730 and the side panel 740 of the automotive protective device 750. The automotive protective device 750 may be housed in a steering wheel 760. During a collision, the automotive protective device 750 may deploy in response to one or more sensors, causing the inflator 770 to rapidly inflate the front panel 730 and the side panel 740 to slow the vehicle occupant's movement in the direction A. While the automotive protective device 750 is shown here as a front driver-side airbag assembly, or airbag system, the automotive protective device 750 may be a variety of devices discussed herein, such as side airbags, knee airbags, curtain airbags, seatbelts, nets, and other devices.

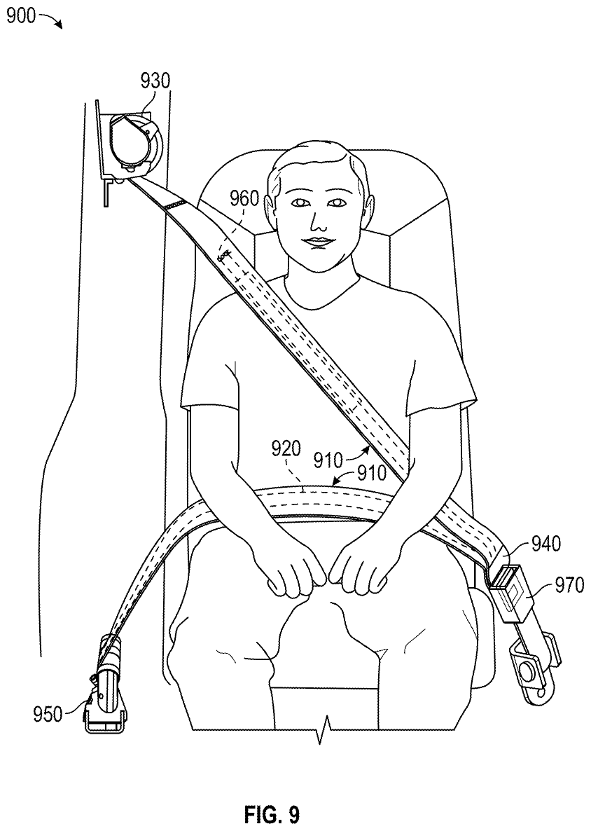

FIG. 8 illustrates a cross-section view of an automotive protective device 800, according to one or more embodiments of the present disclosure. The automotive protective device 800 may be the automotive protective device 750 of FIG. 7, in a non-deployed state. The automotive protective device 800 may include a housing 810. The housing 810 may cover the automotive protective device 800 such that the automotive protective device 800 may deploy rapidly to protect a vehicle occupant during a collision. The automotive protective device 800 may include a textile component 812, such as an airbag cushion. In some embodiments, the textile component 812 may include an RFID thread or RFID ribbon, as discussed herein. The textile component 812 may be folded within the housing 810 when in a non-deployed state. In some embodiments, the textile component 812 may be configured to rapidly inflate to cushion the vehicle occupant during a collision. The automotive protective device 800 may include a non-textile component 814, such as an inflator. The non-textile component 814 may be coupled or attached to the textile component 812. In some embodiments, the non-textile component 814 may be coupled or attached to the textile component 812 at an assembly time, or coupling time. In some embodiments, the non-textile component 814 may inflate the textile component 812. The automotive protective device 800 may include multiple textile components and non-textile components. For example, the multiple textile components may include a tether, an airbag cushion front panel, or an airbag cushion side panel, and the multiple non-textile components may include an inflator, an actuator, or mounting hardware (e.g., bolt, nut, bracket).

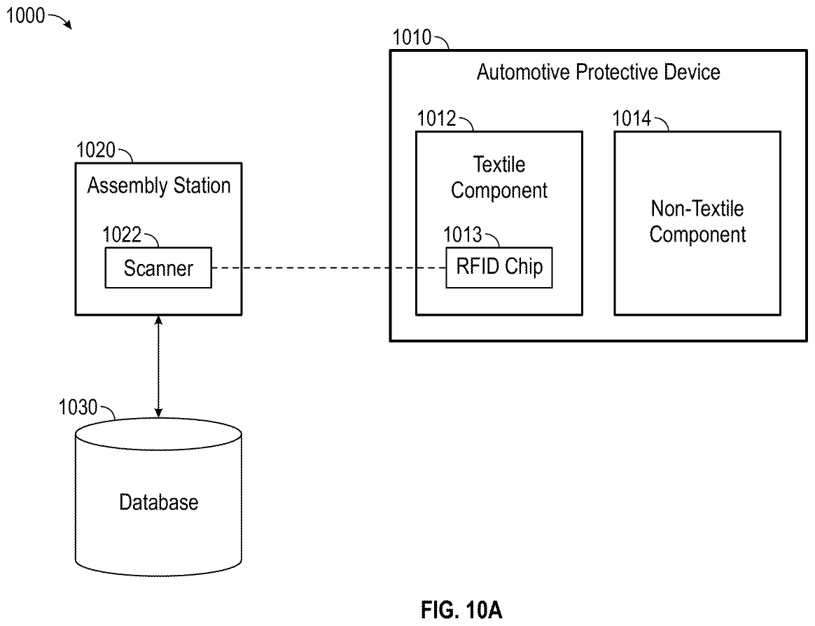

FIG. 9 illustrates another automotive protective device 900, according to one or more embodiments of the present disclosure. The automotive protective device 900 may be a seat belt system. The automotive protective device 900 may include a seat belt 910. The seat belt 910 may be called a seat restraint or a restraining device. In some embodiments, the seat belt 910 may extend across a vehicle occupant's lap and chest. The seat belt 910 may be configured to arrest motion of the vehicle occupant during a collision to prevent injury. The seat belt 910 may be attached to a winch assembly 930 and an anchor 950. The winch assembly 930 may be configured to receive the seat belt 910 in a coiled arrangement. The winch assembly 930 may release the seat belt 910 from the coiled arrangement to allow the seat belt 910 to extend across the vehicle occupant's chest and lap. The winch assembly 930 may be configured to arrest the seat belt 910 and prevent the seat belt 910 from extending in response to a collision. In some embodiments, the winch assembly 930 may prevent the seat belt 910 from extending at speeds exceeding a threshold speed, to restrain the vehicle occupant during a collision. The seat belt 910 may include a buckle 940. The buckle 940 may be removably attached to a buckle receiver 970. The buckle 940 may be attached to the buckle receiver 970 when the seat belt 910 is deployed across the vehicle occupant's chest and lap. The buckle 940 may be detached from the buckle receiver 970 when the seat belt 910 is not deployed. The seat belt 910 may be or include a textile. The seat belt 910 may include stitching 920 and/or stitching 960. The textile of the seat belt 910 and/or the stitching 920 or stitching 960 may include one or more RFID threads or ribbons, such as the RFID thread 100 of FIG. 1 or the RFID ribbon 410 of FIG. 4. In some embodiments, the seat belt 910 may include one or more RFID threads as shown in FIG. 3. The winch assembly 930, the buckle 940, the anchor 950, and the buckle receiver 970 may be non-textile components of the automotive protective device 900. The winch assembly 930, the buckle 940, the anchor 950, and the buckle receiver 970 may include metal, plastic, rubber, and other materials.

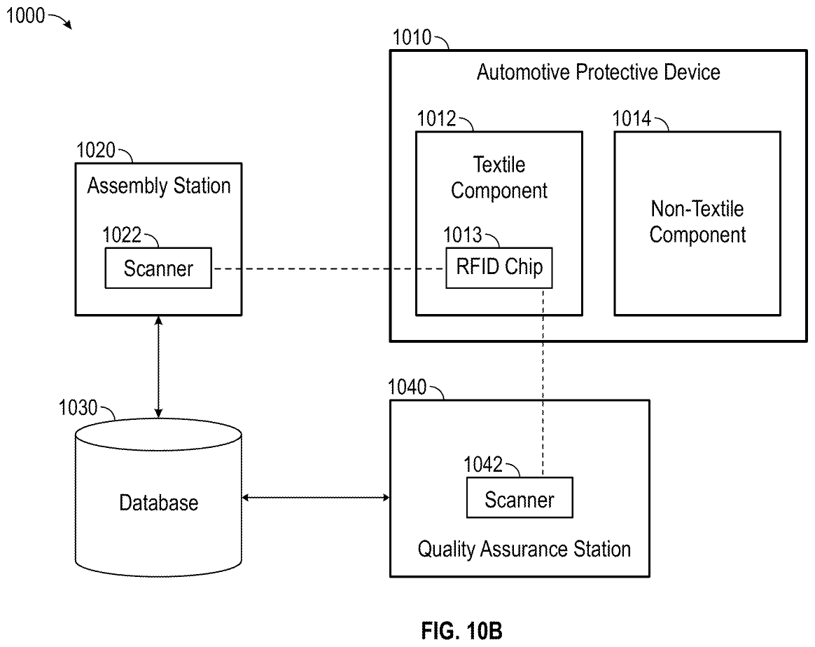

FIG. 10A is a diagrammatic view of a tracking system 1000, according to one or more embodiments of the present disclosure. The tracking system 1000 may include an automotive protective device 1010, an assembly station 1020, and a database 1030. The automotive protective device 1010 may include a textile component 1012 and a non-textile component 1014. The textile component 1012 may include an RFID chip 1013. The assembly station 1020 may include a scanner 1022. The automotive protective device 1010 may be an automotive protective device as discussed herein, such as the automotive protective device 750, the automotive protective device 800, or the automotive protective device 900. The RFID chip 1013 may be incorporated in an RFID yarn or RFID ribbon, as discussed herein. The RFID chip 1013 may be incorporated in or attached to the textile component 1012, as discussed herein.

The assembly station 1020 may be a location for assembling the automotive protective device 1010. The textile component 1012 and/or the non-textile component 1014 may be added to the automotive protective device 1010 at the assembly station 1020 at an assembly time, or coupling time. The assembly time may be a time when the textile component 1012 and/or the non-textile component 1014 are added or coupled to the automotive protective device 1010. In an example, the non-textile component 1014 is coupled to the textile component 1012 at the assembly time. In some embodiments, multiple assembly stations may be used in assembling the automotive protective device 1010. The scanner 1022 may scan the RFID chip 1013 and identify an identifier of the RFID chip 1013. Scanning the RFID chip 1013 may include emitting electromagnetic radiation which stimulates the RFID chip 1013 to emit a signal containing the identifier, and parsing the signal emitted by the RFID chip 1013 to identify the identifier. The assembly station may transmit the identifier to the database 1030. The identifier may be associated with the automotive protective device 1010 in the database 1030. In some embodiments, the identifier may be associated with the automotive protective device 1010 in the database 1030 at the assembly time. The textile component 1012 may be associated with the identifier in the database 1030. The non-textile component 1014 may be associated with the identifier in the database 1030. In some embodiments, the non-textile component 1014 may be associated with the identifier in the database 1030 at the assembly time. In an example, the non-textile component 1014 is identified and then associated with the identifier in the database 1030 when the non-textile component 1014 is coupled to the textile component 1012 at the assembly time. In some embodiments, the assembly station 1020 may associate the automotive protective device 1010, the textile component 1012, and/or the non-textile component 1014 with the identifier in the database 1030. In other embodiments, the database 1030 may associate the automotive protective device 1010, the textile component 1012, and/or the non-textile component 1014 with the identifier based on an identity of the assembly station 1020. The assembly station 1020 may receive information associated with the non-textile component 1014 and transmit that information to the database 1030.

In some embodiments, the automotive protective device 1010 includes multiple RFID chips. In some embodiments, the automotive protective device 1010 includes multiple textile components each including an RFID chip, as well as multiple non-textile components, as discussed herein. Each textile component of the multiple textile components may be associated in the database 1030 with the identifier of the RFID chip in each textile component. As the multiple textile components are added to the automotive protective device 1010, the automotive protective device 1010 can be associated in the database 1030 with the identifier of each RFID chip in each textile component. In some embodiments, the multiple textile components include a first textile component of the automotive protective device and additional textile components. As the additional textile components are added to the automotive protective device 1010, the additional textile components are associated with the identifier of the RFID chip of the first textile component. In some embodiments, the multiple non-textile components are associated with different identifiers. For example, an inflator of the automotive protective device 1010 is associated with a first identifier of a first RFID chip incorporated in an airbag panel based on the inflator being installed subsequent to the airbag panel and a mounting hardware of the automotive protective device 1010 is associated with a second identifier of a second RFID chip incorporated in a tether based on the mounting hardware being installed subsequent to the tether.

In some embodiments, the scanner 1022 scans the RFID chip 1013 before the textile component 1012 is added to the automotive protective device 1010. In other embodiments, the scanner 1022 scans the RFID chip 1013 after the textile component 1012 is added to the automotive protective device 1010.

FIG. 10B is a diagrammatic view of the tracking system 1000a in communication with or including a quality assurance station 1040 (or quality assurance system), according to one or more embodiments of the present disclosure. The quality assurance station 1040 may include a scanner 1042. The quality assurance station 1040 may be a location for checking or verifying the quality and functionality of the automotive protective device 1010. For example, the quality assurance station 1040 may test the inflation of airbags to ensure that the airbags inflate as needed to prevent or mitigate vehicle occupant injury during a collision. The quality assurance station 1040 may be used to identify issues or potential issues in automotive protective devices. For example, the quality assurance station 1040 may identify automotive protective devices for a recall. The scanner 1042 may scan the RFID chip 1013 and identify the identifier of the RFID chip 1013. The quality assurance station 1040 may communicate with the database 1030 to determine what is associated in the database with the identifier. The quality assurance station 1040 may associate an issue, or point of information (e.g., tracking information; quality information), with the identifier in the database 1030. In some embodiments, the quality assurance station 1040 may identify components of the automotive protective device 1010 associated with an issue in the database 1030. In other embodiments, the quality assurance station 1040 may identify automotive protective devices containing components associated with an issue in the database 1030. For example, the quality assurance station 1040 may identify which automotive protective devices are included in a recall based on the automotive protective devices being associated, in the database 1030, with an issue.

In some embodiments, the quality assurance station 1040 may organize the automotive protective devices into batches. The quality assurance station 1040 may organize the textile components of the automotive protective devices into batches. The quality assurance station 1040 may organize the non-textile components of the automotive protective devices into batches. Based on an automotive protective device, a textile component, or a non-textile component of a batch having an issue, the other devices or components in the batch may also be associated with the issue in the database. The quality assurance station 1040 may issue a recall alert on all of the devices and/or components associated with the issue.

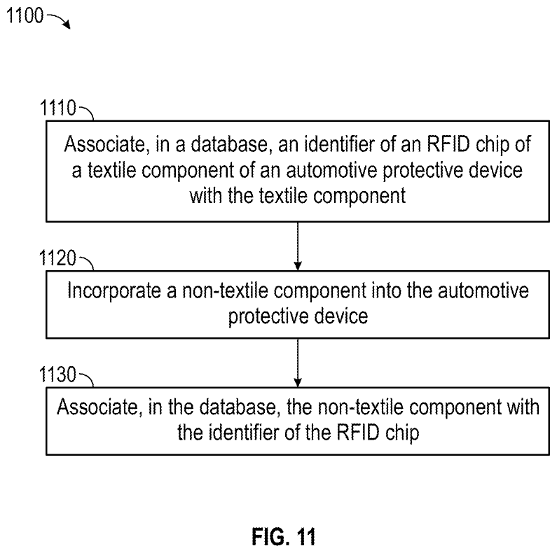

FIG. 11 is a flowchart 1100 illustrating operations of a method for tracking an automotive protective device. In some embodiments, the method may be performed by the assembly station 1020 of FIGS. 10A and 10B. Additional, fewer, or different operations may be included in the method. The operations shown may be performed in the order shown, in a different order, or concurrently.

The method may include associating 1110, in a database, an identifier of an RFID chip of a textile component of an automotive protective device with the textile component. The RFID chip may be incorporated in an RFID chip or RFID ribbon in or attached to the textile component, as discussed herein. The identifier of the RFID chip may be identified by scanning the RFID chip and capturing a signal containing the identifier emitted by the RFID chip in response to scanning. The identifier of the RFID chip may be identified by additional scanners, allowing the identifier of the RFID chip and, using the database, the textile component and/or the automotive protective device, to be identified.

The method may include incorporating 1120 a non-textile component into the automotive protective device. Incorporating 1120 the non-textile component into the automotive protective device may include assembling the automotive protective device including the non-textile component.

The method may include associating 1130, in the database, the non-textile component with the identifier of the RFID chip. The non-textile component may be identified using the identifier of the RFID chip such that scanning the RFID chip allows for identifying the non-textile component.

For example, the textile component may be an airbag cushion of an airbag assembly and the airbag cushion and/or airbag assembly may be identified by scanning an RFID chip incorporated into an RFID thread in the airbag cushion. In this example, the non-textile component may be an inflator of an airbag assembly and incorporating the inflator into the airbag assembly may include attaching the inflator to the airbag cushion of the airbag assembly. In this example, the inflator of the airbag assembly may be associated, in the database, with the identifier of the of the RFID chip such that scanning the RFID chip in the textile component allows for identifying the non-textile component.

Throughout this specification, the phrases “coupled to” and “in communication with” refer to any form of interaction between two or more entities, including mechanical, electrical, magnetic, electromagnetic, fluid, and thermal interaction. Two components may be coupled to each other even though they are not in direct contact with each other. The terms “abut” and “abutting” refer to items that are in direct physical contact with each other, although the items may not necessarily be attached together.

As used herein, inboard refers to a direction toward a centerline of a vehicle and outboard refers to a direction out of the vehicle and away from a centerline of the vehicle.

The phrases “attached to” or “attached directly to” refer to interaction between two or more entities which are in direct contact with each other and/or are separated from each other only by a fastener of any suitable variety (e.g., mounting hardware or an adhesive).

The phrase “fluid communication” is used in its ordinary sense, and is broad enough to refer to arrangements in which a fluid (e.g., a gas or a liquid) can flow from one element to another element when the elements are in fluid communication with each other.

The terms “a” and “an” can be described as one, but not limited to one. For example, although the disclosure may recite an airbag having “a chamber,” the disclosure also contemplates that the airbag can have two or more chambers.

The terms “longitudinal” and “longitudinally” refer to a direction or orientation extending or spanning between a front of a vehicle and a rear of the vehicle.

As used herein, the terms “forward” and “rearward” are used with reference to the front and back of the relevant vehicle. For example, an airbag cushion that deploys in a rearward direction deploys toward the back of a vehicle. Furthermore, other reference terms, such as horizontal, are used relative to a vehicle in which an airbag assembly is installed, unless it is clear from context that a different reference frame is intended. Thus, a term such as “horizontal” is used relative to the vehicle, whether or not the vehicle itself is oriented horizontally (e.g., is positioned upright on level ground) or angled relative to true horizontal (e.g., is positioned on a hill).

Unless otherwise stated, all ranges include both endpoints and all numbers between the endpoints.

The phrase “vehicle seating position” refers to the position in which an occupant is generally positioned when seated in a seat of a vehicle. The term “occupant” refers to a person or crash test dummy within a vehicle.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 ¶6. It will be apparent to those having skill in the art that changes may be made to the details of the above-described embodiments without departing from the underlying principles of the invention. Embodiments of the invention in which an exclusive property or privilege is claimed are defined as follows.

1. An automotive protective device that is configured to be mounted to a vehicle to provide protection to an occupant of a vehicle during a collision event, the automotive protective device comprising:
a textile component formed of a textile and including an RFID chip, wherein the textile component is associated, in a database, with an identifier of the RFID chip; and
a non-textile component coupled to the textile component and associated, in the database, with the identifier of the RFID chip, wherein the non-textile is associated with the identifier of the RFID chip at an assembly time when the non-textile component is coupled to the textile component.

2. The automotive protective device of claim 1, wherein the automotive protective device is an airbag system and the textile component is a panel of an inflatable airbag cushion of the airbag system.

3. The automotive protective device of claim 1, wherein the automotive protective device is a safety belt, wherein the textile component is a woven strap of the safety belt.

4. The automotive protective device of claim 1, wherein the non-textile component is one of a housing, an inflator, and a mounting hardware component.

5. The automotive protective device of claim 1, wherein the RFID chip is incorporated in a yarn of material woven to form the textile.

6. The automotive protective device of claim 1, wherein the RFID chip is incorporated in a ribbon incorporated into the textile component.

7. The automotive protective device of claim 1, wherein the automotive protective device further comprises a second textile component associated with the identifier of the RFID chip at an attachment time when the second textile component is attached to the textile component.

8. A system comprising:
a database; and
an assembly station for assembling an automotive protective device that is configured to be mounted to a vehicle to provide protection to an occupant of a vehicle during a collision event, the assembly station comprising a scanner configured to:
scan an RFID chip of a textile component of the automotive protective device to determine an identifier of the RFID chip, wherein the textile component is associated with the identifier of the RFID chip in the database;
receive information associated with a non-textile component of the automotive protective device;
add the non-textile component to the automotive protective device; and
associate, in the database, the non-textile component of the automotive protective device with the identifier of the RFID chip.

9. The system of claim 8, wherein the automotive protective device is an airbag system and the textile component is a panel of an inflatable airbag cushion of the airbag system.

10. The system of claim 8, wherein the automotive protective device is a safety belt, wherein the textile component is a woven strap of the safety belt.

11. The system of claim 8, wherein the non-textile component is one of a housing, an inflator, and a mounting hardware component.

12. The system of claim 8, wherein the RFID chip is incorporated in a yarn of material woven to form the textile.

13. The system of claim 8, wherein the RFID chip is incorporated in a ribbon incorporated into the textile component.

14. A method for manufacturing an automotive protective device configured to be mounted to a vehicle to provide protection to an occupant of a vehicle during a collision event, the method comprising:
associating, in a database, an identifier of an RFID chip of a textile component of the automotive protective device with the textile component;
incorporating a non-textile component into the automotive protective device; and
associating, in the database, the non-textile component with the identifier of the RFID chip.

15. The method of claim 14, further comprising identifying a point of information pertaining to one or more of the textile component and the non-textile component;
determining, the RFID identifier based on an association between the point of information and the RFID identifier in the database; and
identifying one or more other components associated with the defective components based on the RFID identifier.

16. The method of claim 14, wherein the automotive protective device is an airbag system and the textile component is a panel of an inflatable airbag cushion of the airbag system.

17. The method of claim 14, wherein the automotive protective device is a safety belt, wherein the textile component is a woven strap of the safety belt.

18. The method of claim 14, wherein the non-textile component is one of a housing, an inflator, and a mounting hardware component.

19. The method of claim 14, wherein the RFID chip is incorporated in a yarn of material woven to form the textile.

20. The method of claim 14, wherein the RFID chip is incorporated in a ribbon that is incorporated into the textile component.
